(19) United States
(12) Patent Application Publication
(10) Pub. No.: US 2007/0061184 A1
(43) Pub. Date: Mar. 15, 2007

(54) Estimation System

(76) Inventor: John J. Clark, Tomball, TX (US)

Correspondence Address: GREENBERG & LIEBERMAN, LLC, 2141 WISCONSIN AVE, N.W., SUITE C-2, WASHINGTON, DC, 20007, US

(21) Appl. No.: 11/531,511

(22) Filed: Sep. 13, 2006

Related U.S. Application Data
(60) Provisional application No. 60/596,289, filed on Sep. 13, 2005.

(51) Int. Cl. G06Q 99/00; G05B 19/418; G06F 15/02; G07G 1/00; G06F 9/46

(52) U.S. Cl. 705/9; 705/1; 705/10; 705/8

(57) ABSTRACT

An assessment notation method for use in determining the scope and cost of repairs. As assessor is able to mark boxes, on paper or an electronic device, that correspond to various types of repairs or alterations. Within each box is a subfield that allows for more precise assessments of needed repairs or alterations. Each box and subfield is associated with a number, which is used to calculate the total cost of repairs or alterations needed. The boxes are color-coded to help the assessor visually distinguish among various types of repairs or alterations.

### CONTINUITY DATA

This is a nonprovisional of provisional U.S. provisional patent application Ser. No. 60/596,289 filed on Sep. 13, 2005, and priority is claimed thereto.

### FIELD OF THE INVENTION

The present invention relates to a system for estimating repairs on structures that have been damaged. More particularly, the present invention is a shorthand system for noting needed repairs that can then be read by an employee in an office sitting in front of a computer; that employee not being familiar with repairs, but able to read the shorthand notations, so that a proper estimate for repair can be completed by some other than the estimator or adjustor.

### BACKGROUND OF THE INVENTION

Whether the result of natural disasters, or simply the result of poor construction, damaged structures can be extremely costly. The cost is not just a problem for the homeowner, or the structure owner, but also, the cost becomes a problem for the insurance company that insures the home or insures the structure. Typically, the bulk of the cost of repair work is actually doing the repair work: buying the materials and paying laborers to actually put on a new roof, paint a new room, rebuild a damaged wall, et cetera. However, a certain amount of the cost of a repair has to do with determining what needs to be repaired and preparing the paperwork that needs to not only go to the owner of the home or structure, but also to the insurance company. The preparation of the paperwork takes time, and the paperwork actually begins as soon as an experienced estimator or adjustor arrives at the home or structure.

The estimator or adjustor is typically somebody with a great deal of experience. Somebody who is experienced demands a high salary. It is rather common to find an estimator/adjustor walking around a damaged home or structure, determining the amount of damage all while noting the information on a pad of paper, or possibly a laptop computer. The very fact that an experienced estimator/adjustor, cannot fully devote himself or herself to merely looking at the damage, estimating repair costs and recommending solutions, is a problem. The estimator is forced to constantly be his or her own secretary, or scribe: drawing pictures of damage, noting materials to be used for replacement, noting the extent of damage and many other very specific repair recommendations, that once made, will go back to a central office for more processing, to be submitted to the homeowner or structure owner and the insurance company. There is a need to allow the expensive estimator/adjustor, who actually visits the site of damage, to be able to fully function without the need to waste precious, billable time on sundry tasks, such as jotting down notes that only he or she can interpret later to input into the estimate. The use of the special “take-off” sheets enables someone else to input the estimate into the computer saving significant time and money for the estimator/adjustor.

U.S. Pat. No. 6,037,945, issued on Mar. 14, 2000, to Loveland shows a graphical method for modeling and estimating construction costs. Unlike the present invention, Loveland's device is concerned with providing a method for graphically estimating attributes of a room through a user interface that is capable of intuitively sizing a graphical representation or model of the room or chamber undergoing estimation. Loveland's device provides a graphical approximation of the chamber or room undergoing estimation, and associates attributes with the facets or planes of the model. Unlike the present invention, Loveland's device does not save time in the work field by allowing the experienced estimator to quickly note repairs that need to be made. Nor does Loveland's device allow for a full estimation and repair report to be later prepared from the notes made by the estimator in an office by an employee with much less experience than the estimator. Nor does Loveland's device allow for a full estimation repair report to be entered via a simple interface that records information into a database or for later uploading to a database.

U.S. Pat. No. 5,893,082, issued on Apr. 6, 1999, to McCormick for a system for processing and presenting cost estimates in the construction industry shows a computer system that includes a CPU, input hardware, output hardware and a memory unit. Unlike the present invention, McCormick's device is concerned with a hardware solution to solving the problem of estimation techniques used in the field by an experienced estimator. Unlike the present invention, McCormick's device does not provide a shorthand notation system to be used by an estimator in the field, to save the estimator time, that can then be read in an office by an individual inexperienced in estimation, but certainly capable of reading a shorthand notation and entering it into a computer system. Nor does McCormick's device allow for a full estimation repair report to be entered via a simple interface that records information into a database or for later uploading to a database.

U.S. Pat. No. 5,546,564, issued on Aug. 13, 1996, to Hori shows a cost estimating system. Hori's device is concerned with calculating data value or construction cost of the highest probability, corresponding to a desired factor, on the basis of a variety of data defined by a plurality of factors, such as rough construction costs of the building. Hori's device provides a data processing apparatus that is capable of calculating a probability value corresponding to a desired factor of a plurality of data easily, and without reducing the total data amount to be processed. Unlike the present invention, Hori's device is unconcerned with saving time for the estimator in the field; unconcerned with the labor cost of the estimator; and is unconcerned with providing a way for the estimator to quickly make notations and move to the next site to be estimated, allowing the detailed report to be provided by a lower cost, less experienced employee in an office setting. Nor does Hori's device allow for a full estimation repair report to be entered via a simple interface that records information into a database or for later uploading to a database.

U.S. Pat. No. 5,307,451, issued on Apr. 26, 1994, to Clark shows a method and apparatus for generating and manipulating graphical data for display on a computer output device. Clark's device is concerned with display of geometry and, unlike the present invention, is not concerned with a shorthand system allowing an estimator in the field to determine the extent of damage, the need for repair, the cost of repair, et cetera. Furthermore, Clark's device does not contemplate or explain a system allowing somebody in the field, who is high cost, to make quick notations that can then be read easily by somebody who is inexperienced back in an office environment, so that the data and estimations and sizes can then be put into a computer system. Nor does Clark's device allow for a full estimation repair report to be entered via a simple interface that records information into a database or for later uploading to a database.

U.S. Pat. No. 5,189,606, issued on Feb. 23, 1993, to Burns et al shows an integrated construction cost estimating analysis and reporting system. Burns et al's device is directed to an expert knowledge-based computer system, having an inference engine applied to an integration construction cost generator, which may be used to develop costs for construction projects, to analyze and estimate facilities associated with major weapons programs, for administrative, medical and support facilities, as well as runway taxis and for developing the lifecycle costs for various construction projects. Burns et al's device uses parametric estimating techniques with a finite field of both codified and unstructured data elements in a unique process, which may be accomplished with or without detailed plans or specifications. Burn et al's device does not allow for a full estimation repair report to be entered via a simple interface that records information into a database or for later uploading to a database.

For example, the system contains more than 900 types of Air Force facilities, as well as the quantities of each product required to complete each building type. Unlike the present invention, Burns et al's device is not a simple shorthand system for an experienced estimator in the field. Unlike the present invention, Burns et al's device is not intended, nor designed for use, for a residential or other structure that has been damaged, and is in need of repair, with the goal of holding costs down as much as possible for the estimator's time. Unlike the present invention, Burns et al's device does not provide a system that can be read in an office by an individual who is inexperienced with estimation techniques and shorthand.

U.S. Pat. No. 4,970,666, issued on Nov. 13, 1990, to Welsh et al, shows a computerized video imaging system for creating a realistic depiction of a simulated object in an actual environment. Unlike the present invention, Welsh et al's device is unconcerned with providing a shorthand simple estimation checklist, but rather, Welsh et al's device focuses on providing a system and method to produce a highly realistic video image, depicting the appearance of a simulated structure in an actual environment. Nor does Welsh et al's device allow for a full estimation repair report to be entered via a simple interface that records information into a database or for later uploading to a database.

Thus, there is a need to provide a quick and easy system for an experienced estimator in the field at the site of a residence that has been damaged, or at the site of a building that has been damaged, a simple, efficient way of noting repairs that must be made. There is a need for a system that will allow a checklist, so that an estimator can quickly move through, item by item, what needs to be repaired in a sequential logistical order. Moreover, there is a need for a graphical representation to be made if, for some reason, a checklist system does not apply to a particular situation. Moreover, there is a need for this quick checklist to be essentially devoid, or nearly devoid, of notations by the estimator, meaning that the estimator will not have to actually write words; the estimator will merely prepare the take-off sheets, and then later, a less expensive, less experienced person in an office environment can look at these notations made by the estimator, and quickly and easily, without any detailed knowledge of the estimation process, input the information into a computer program, so that a full estimation report can be prepared. Further, there is a need for a full estimation repair report to be entered via a simple interface that records information into a database or for later uploading to a database.

### SUMMARY OF THE INVENTION

The present invention provides sheets of paper that are set up to allow an estimator in the field to quickly note what needs to be repaired, the extent of repair that is necessary and the materials to be used in the repair in a logical work progression. In addition, the present invention provides space for a graphical representation to be made by the estimator of the structure depicting room or area sizes, shapes and the location of damages. The present invention has sheets for notation that have more than 4,000 items or services flowing from the ceiling of a structure to the floor of the structure or from the floor to the ceiling. Thus, the present invention covers over 90% percent of the possible services that could be applied to a given room or area on the average residential or commercial loss. The present invention provides all these services on one sheet of paper for interior rooms or area damages and one sheet for exterior damages. This makes the present invention very unique in the field. An estimator could use the present invention to quickly note on one sheet of paper what is needed for a room, and then pull out another sheet of paper that is identical to the first sheet of paper for the next room or area, and so on. A separate sheet of paper of the present invention is provided for repair work estimation for the exterior of the home or structure.

The beauty of the present invention is not only the consolidation of the repair work or services on one sheet per room, or one sheet for the exterior of the home or structure, so that the estimator could move quickly in noting what needs to be done, but moreover, the present invention has a quick shorthand notation system that the estimator can use, that can be later read by somebody completely unfamiliar with the estimation process back in an office. That person who is unfamiliar with the estimation process merely needs to look at the sheets of the present invention and input numbers into a computer, and then a proper report can be generated that is equivalent to what the estimator actually would have done in the field, had the estimator written out a report by hand. Alternatively, the present invention allows for a full estimation repair report to be entered via a simple interface that records information into a database or for later uploading to a database rather than need to rely on a person who is unfamiliar with the estimation process merely needs to look at the sheets of the present invention and input numbers into a computer.

The present invention employs color-coded rectangles on notation sheets, as well as circles and numbers. The circles and numbers, when shaded and chosen by the estimator, indicate that certain repairs need to be made. When read back in an office by somebody who is not familiar with the estimation process, that person merely needs to read the numbers, and look at the circles that correspond to additional numbers, so that a final number can be input into computer software. The computer software then merely matches the number to a specific type of repair that needs to be made, and the item number pulls up the description, trade, and price from the price list. The program will then generate a detailed estimate and total cost of repairs.

### BRIEF DESCRIPTION OF THE FIGURES

FIG. 1 shows a first sheet of the present invention.

FIG. 2 shows a second sheet of the present invention.

FIG. 3 shows a third sheet of the present invention.

FIG. 4 shows a fourth sheet of the present invention.

### DETAILED DESCRIPTION OF THE PREFERRED EMBODIMENT(S) OF THE PRESENT INVENTION

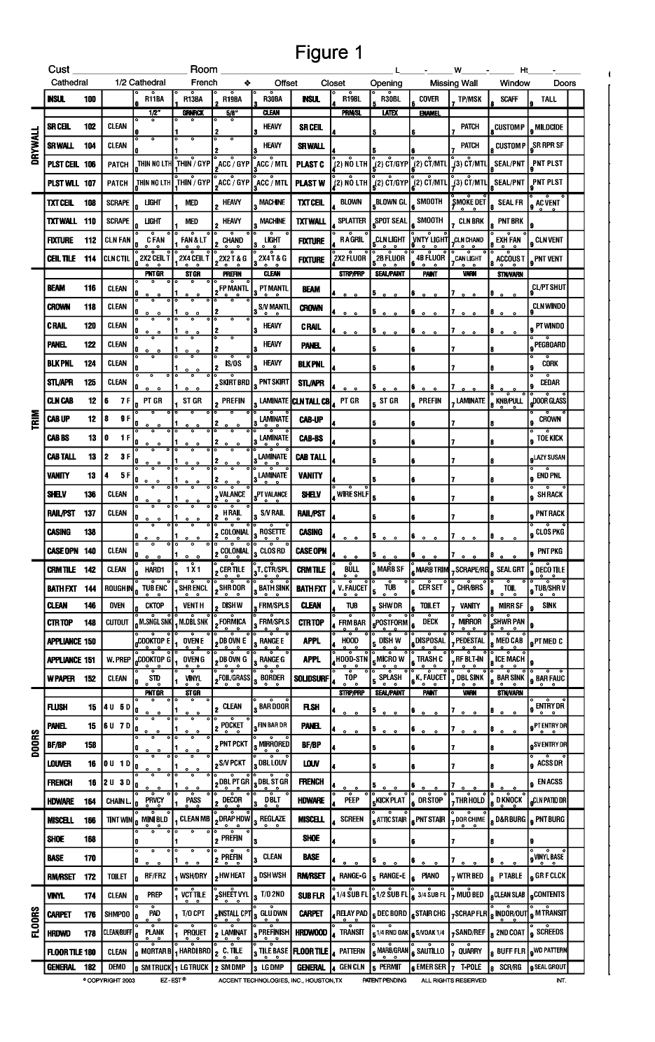

As shown in FIG. 1, the present invention has a series of rows and columns disposed on a first side of a sheet of paper. The rows along the left side of the first side of the sheet of paper represent different items that would need to be repaired. As shown in FIG. 1, this first side of a sheet of paper represents repairs that would need to be made to a single room or area. Thus, the user would actually use multiple copies of the first side of the sheet of paper as shown in FIG. 1. Each copy would be for a different room of a structure or home that needs to be repaired.

Short abbreviations are shown for each of the rows. As shown in FIG. 1, in the preferred embodiment of the present invention in the extreme left rectangle of each of the rows, reading from the upper left row to the bottom left row, the abbreviations represent the following: insulation, sheetrock ceiling, sheetrock wall, plaster ceiling, plaster walls, texture ceiling, texture wall, fixture, ceiling tile, beam, crown, chair rail, panel, block panel, stool apron, cabinets—wall, cabinets—base, cabinets—tall, vanity, shelving, rail post, door casing, case opening, ceramic tile, bath fixtures, clean, countertop, appliance, wallpaper, flush, panel, bi-fold bypass door, louvered, French, hardware, miscellaneous, (shoe), base, remove and reset, vinyl, carpet, hard wood, floor tile and general. The sheets use these abbreviations in order to save space and make reading the information upon them less burdensome. The abbreviations used are such that an average person skilled in the field would understand what the abbreviation would stand for. In an alternative embodiment of the invention, different abbreviations could be used for different typical building materials or services. The purpose of the abbreviations is to identify any typical home materials, such as those listed above, that may need to be identified for preparing the scope of repairs or remodeling.

The rows are indicated as being part of the group. For example, in the preferred embodiment of the invention in FIG. 1, a thicker line dividing the rows, plaster walls and texture ceiling, shows that the sheet rock ceiling, the sheet rock wall, the plaster ceiling, the plaster walls, all belong to the drywall subgroup, and the word “drywall” appears to the left of those rows to indicate such.

Similarly, in the preferred embodiment of the present invention the word “doors” appears to the left of the group of rows termed flush, panel, bi-fold bypass door, louvered, French and hardware. The word “trim” appears to the left of the rows, beam, crown, chair rail, panel, block panel, stool apron, cabinets—wall, cabinets—base, cabinets—tall, vanity, shelving, rail post, door casing, door opening. Similarly, the word “floors” appears to the left of the rows, vinyl, carpet, hard wood, floor tile.

It is important to note that the left-most rectangles, as shown in FIG. 1, have numbers associated with the abbreviations for each of the items. For example, insulation, as shown in the upper left box, represented by the abbreviation INSUL, has a number 100 next to it. Similarly, sheet rock ceiling, as represented by the abbreviation SRCEIL, has the number 102 as part of its rectangle.

These numbers in each of these left-most rectangles represent the first digits in a number that will be entered by a data entry person from the notations made on these sheets.

The columns of the present invention, as shown in FIG. 1 on the first sheet, represent details about each of the items represented in the left-most rectangles. For example, the rectangles to the right of the insulation rectangle that is located in the upper left portion in FIG. 1, represent different types of insulation. In the preferred embodiment of the invention, reading from left to right, the rectangles in the columns to the right of the insulation rectangle are R11 BAT, R13 BAT, R19 BAT, R30 BAT, R19 (BLOWN), R30 (BLOWN), COVER, TAPE MASK, SCAFFOLDING and TALL.

In the preferred embodiment of the invention, it is important to note that the first sheet, as shown in FIG. 1, has blue columns. The first blue column begins with INSULATION in the top left corner and runs all the way down the left side until it ends at the word “GENERAL” on the very bottom left. This first blue column acts as a visual guide, so that the user, the estimator/adujustor, will quickly see the different row of titles. A second blue column identical to the first blue column, but not having the numbers after each abbreviation, is positioned down the center of the first sheet of the present invention. This second blue column is, again, a visual guide and allows the user/estimator/adjustor another visual guide to determine which row they are marking details for, without having to move their eye and reference the row indication all the way on the left.

For example, if the user/estimator/adjustor is in the row of SR CEIL (102) and the user/estimator/adjustor is indicating that mildeside is needed, the user will be marking a box toward the upper right of the first sheet of the present invention, and the second blue column marked SR CIEL will remind the user that the user is actually in the SR CIEL row.

Of note is that the preferred embodiment of the present invention has, on the first sheet, three blue rows that extend completely across the first sheet. As shown in FIG. 1, the first blue row that extends completely across the sheet is between INSULATION and SHEET ROCK CEILING. That row has boxes that indicate ½ inch (GREEN) ROCK, ⅝ of an inch, PRIME SEAL. In the preferred embodiment of the invention, blue boxes on the sheet will signify titles and headings, pink will signify a painting function, yellow will signify cleaning service, green will signify “set length” items for lumber items that need length information, and white will signify cells requiring no extra attention drawn to their presence.

Gray boxes in the horizontal title/service sequence merely represent empty space. However, whenever something is written in a gray box, it may supercede the title or heading written in the blue heading box above the gray box. While the sheet is colored as above in the present embodiment, such coloring is not necessary. The preferred embodiment possesses the above coloration scheme in order to make identification of particular repair areas simpler. In alternative embodiments, the colors could be different and/or different repair areas could receive the coloring.

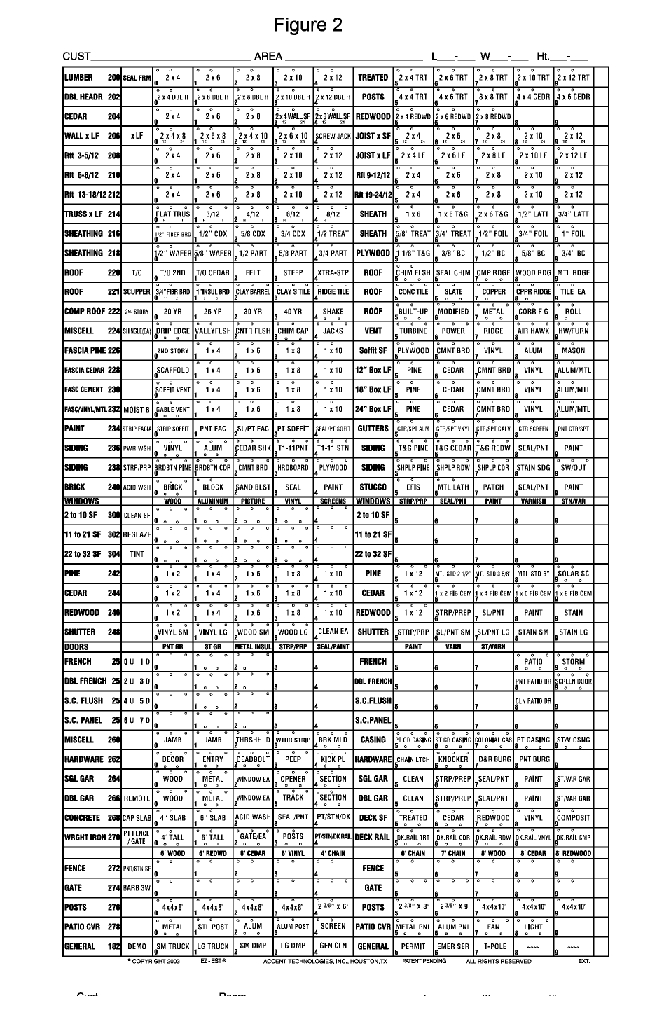

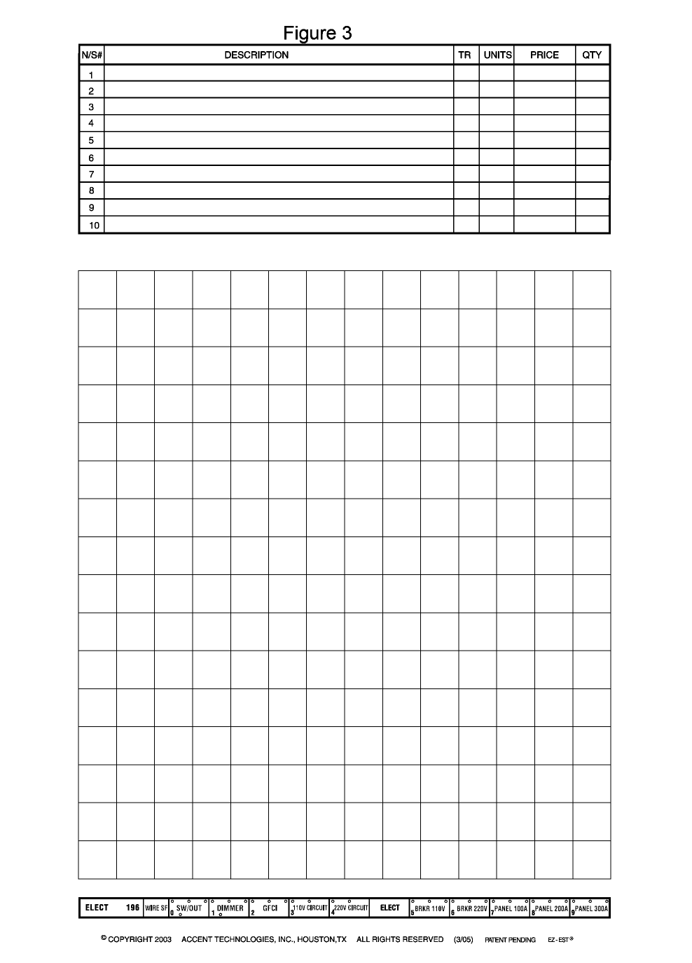

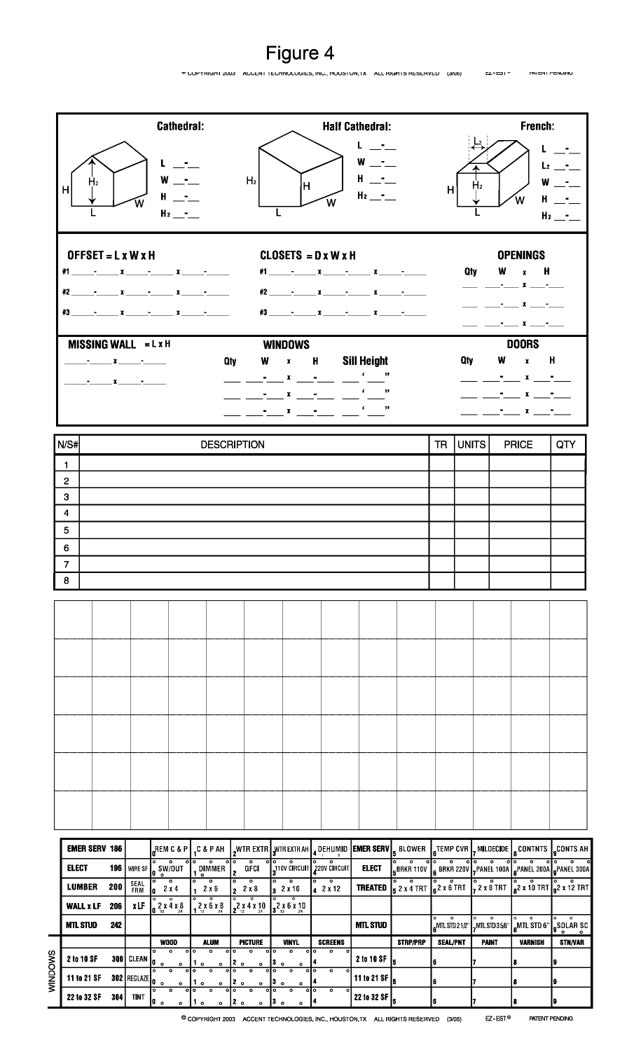

FIGS. 2, 3, and 4 show other items that can be arranged per the present invention. FIGS. 3 and 4, in particular, provide space so that supplemental information and/or drawings can be included when estimation work is done.

The present invention is not limited solely to the ebodiment(s) described above, but is any and all of the embodiments within the scope of the following claims.

I claim:

1. A notation system for estimating costs of repairs or alterations, comprising:
selecting fields corresponding to tasks;
selecting subspaces within the fields, corresponding to different sub tasks;
providing numbers corresponding to the fields and subspaces; and
generating a cost estimate based upon the numbers.

2. The system of claim 1, wherein said fields are check boxes or fill-in boxes.

3. The system of claim 1, wherein said numbers are provided within said fields and subspaces.

4. The system of claim 1, wherein said fields are arranged in a grid.

5. The system of claim 4, wherein the left-most column of said grid represents different items that would need to be repaired.

6. The system of claim 4, wherein descriptive abbreviations are provided for each of the rows of said grid.

7. The system of claim 6, wherein said descriptive abbreviations represent typical home materials.

8. The system of claim 1, wherein said generating a cost estimate is performed by a computer or other electronic device.

9. The system of claim 3, wherein said numbers in each field or subspace signify repairs or alterations, or degrees or costs thereof, and may be entered into a computer or other electronic device.

10. The system of claim 4, wherein the columns of said grid, other than the left-most column, represent details for each item represented in the left-most column.

11. The system of claim 5, wherein said left-most column has a background color to visually distinguish it from other columns.

12. The system of 4, wherein said grid is color-coded by row and by column to visually distinguish certain fields.

13. The system of claim 1, further comprising notation space for graphical representations.

14. The system of claim 1, wherein said fields and subspaces to be selected are provided on a paper medium.

15. The system of claim 1, wherein said fields and subspaces to be selected are provided in an electric medium.

16. An assessment or appraisal notation system, comprising:
selecting fields from a color-coded grid containing fields; and
generating an assessment or appraisal based on the fields selected from the grid.

17. The system of claim 16, wherein the left-most column of said grid contains fields describing various aspects of the subject being assessed or appraised.

18. The system of claim 16, further comprising subfields contained within said fields to provide more detail regarding the subject being assessed or appraised.

19. The system of claim 18, further comprising associating numbers with said fields and subfields.

20. The system of claim 19, wherein said generating an assessment or appraisal is done by associating said numbers with costs or other information.
